(19) United States
(12) Patent Application Publication
(10) Pub. No.: US 2011/0309142 A1
(43) Pub. Date: Dec. 22, 2011

(54) PAYMENT CARD READER APPARATUS AND METHOD OF OPERATING A PAYMENT CARD READER APPARATUS

(75) Inventor: Henry Thomas Miller, Lawrenceville, GA (US)

(73) Assignee: NCR CORPORATION, Duluth, GA (US)

(21) Appl. No.: 12/817,450

(22) Filed: Jun. 17, 2010

(51) Int. Cl. G06K 7/00; G06Q 30/00; G06Q 40/00

(52) U.S. Cl. 235/380

(57) ABSTRACT

A payment card reader apparatus is provided for enabling a retail customer purchasing goods or services from a retail establishment to make payment for purchased goods or services. A housing enclosure has a front panel which faces toward the retail customer and an interior chamber located behind the front panel. A payment card reader portion is disposed in the interior chamber and is provided for receiving a payment card from the retail customer. A customer input pad portion is disposed in the interior chamber and is provided for (i) receiving input data from the retail customer after the payment card reader portion has received a payment card from the retail customer, and (ii) providing a trigger signal in response to receiving input data from the retail customer. An actuatable camera portion is disposed in the interior chamber and is provided for, when actuated in response to the trigger signal, capturing an image of the retail customer while the retail customer is providing input data to the customer input pad portion.

### BACKGROUND

The present invention relates to payment card readers, and is particularly directed to a payment card reader apparatus and method of operating a payment card reader apparatus.

A typical payment card reader apparatus may comprise a combination of a credit card reader and a signature capture pad. The payment card reader apparatus may be located at either a self-service type of checkout terminal or a point-of-sale (POS) type of terminal to allow a retail customer purchasing goods or services from a retail establishment to make payment for purchased goods or services. More specifically, the retail customer swipes a credit card using the credit card reader, and then provides an electronic signature using the signature capture pad to make payment for the purchase transaction.

In some known retail establishments, a camera separate from the payment card reader apparatus is used to take a picture of the retail customer while the retail customer is conducting the purchase transaction. The picture is used as proof of occurrence of the purchase transaction in the event there is a dispute in the future as to whether the purchase transaction had ever occurred. Since the cameras in these known retail establishments are separate from the payment card reader apparatus, these cameras sometime do not take a good picture of the retail customer while the retail customer is conducting the purchase transaction. As an example, the retail customer may not be looking into the camera when the picture is taken. As another example, the retail customer may be out of the picture altogether, depending upon specific location of the camera relative to where the payment card reader apparatus is located and where the retail customer is standing when the picture is taken. It would be desirable to provide an improved arrangement of a camera and a payment card reader apparatus so that a good picture of a retail customer conducting a purchase transaction at a self-service type of terminal or a POS type of terminal is better ensured.

### SUMMARY

In accordance with one embodiment of the present invention, a payment card reader apparatus is provided for enabling a retail customer purchasing goods or services from a retail establishment to make payment for purchased goods or services. A housing enclosure has a front panel which faces toward the retail customer and an interior chamber located behind the front panel. A payment card reader portion is disposed in the interior chamber and is provided for receiving a payment card from the retail customer. A customer input pad portion is disposed in the interior chamber and is provided for (i) receiving input data from the retail customer after the payment card reader portion has received a payment card from the retail customer, and (ii) providing a trigger signal in response to receiving input data from the retail customer. An actuatable camera portion is disposed in the interior chamber and is provided for, when actuated in response to the trigger signal, capturing an image of the retail customer while the retail customer is providing input data to the customer input pad portion.

### BRIEF DESCRIPTION OF THE DRAWINGS

In the accompanying drawings:

FIG. 1 is a schematic block representation of a payment card processing system;

FIG. 2 is a perspective view of a self-service retail item checkout station which may be used in the system of FIG. 1;

FIG. 3 is a schematic block representation of certain components of a payment card reader apparatus which is used in the self-service retail item checkout station of FIG. 2;

FIG. 4 is a front view of a payment card reader apparatus which is constructed in accordance with a first embodiment of the present invention;

FIG. 5 is a front view of a payment card reader apparatus which is constructed in accordance with a second embodiment of the present invention;

FIG. 6 is a front view of a payment card reader apparatus which is constructed in accordance with a third embodiment of the present invention;

FIG. 7 is a flowchart depicting operation of the payment card reader apparatus shown in FIG. 4; and

FIG. 8 is a flowchart depicting operation of either the payment card reader apparatus shown in FIG. 5 or the payment card reader apparatus shown in FIG. 6.

### DETAILED DESCRIPTION

The present invention relates to payment card readers, and is particularly directed to a payment card reader apparatus and method of operating a payment card reader apparatus.

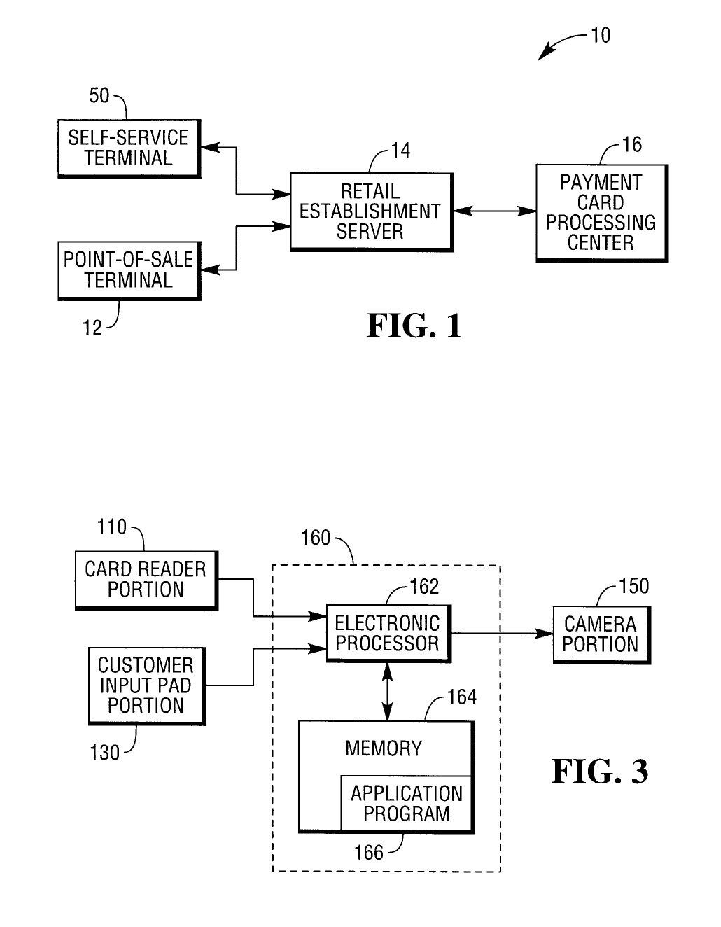

Referring to FIG. 1, a schematic block representation of a payment card processing system 10 comprises a self-service type of terminal 50 and a point-of-sale (POS) type of terminal 12. The system 10 further includes a retail establishment server 14 which communicates with the self-service terminal 50 and the POS terminal 12. The system 10 also includes a payment card processing center 16, such as a credit card processing center which communicates with the retail establishment server 14. Communications between the server 14 and the self-service terminal 50, communications between the server 14 and the POS terminal 12, and communications between the server 14 and the payment card processing center 16 are known and, therefore, will not be described.

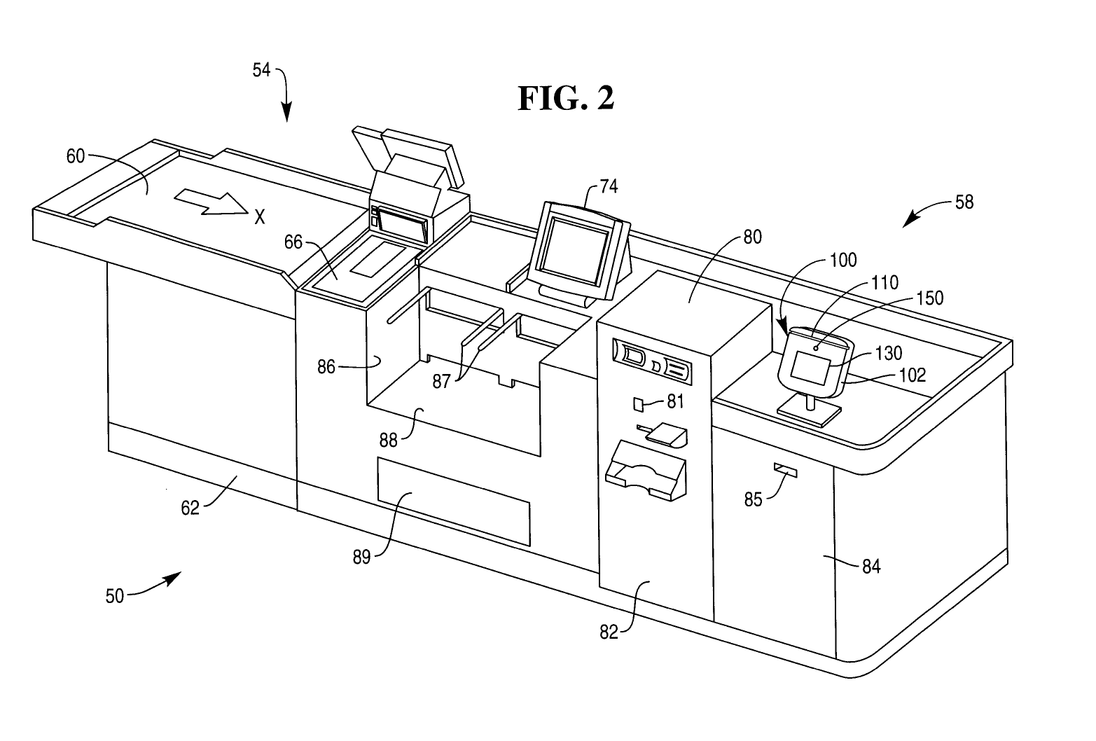

The self-service terminal 50 shown in FIG. 1 may comprise a self-service retail item checkout station such as shown in FIG. 2 and designated with reference number “50”. The self-service retail item checkout station 50 allows a retail customer to conduct a self-service retail item checkout transaction which involves a sale of retail items (such as groceries for example) to the customer. The customer may make cash payment for the purchase of such goods, and receive cash change back after cash payment has been made.

The checkout station 50 may include a feeder unit 54 and a checkstand unit 58. Feeder unit 54 includes a feeder belt 60 and housing 62 for motor and control circuitry that operates the feeder belt. Feeder unit 54 is movably coupled to checkstand unit 58 so the feeder belt 60 may be aligned with a scanner/scale module 66 of the checkstand unit 58.

Checkstand unit 58 includes the scanner/scale module 66, a customer interface terminal 74, an upper currency module 80, a lower currency module 82, and a receipt printer module 84. Scanner/scale module 66 uses a laser shining on a glass or other transparent platen to input data from bar codes applied to products or packages. Scanner/scale module 66 may also include a scale for measuring the weight of articles that are sold on a price/unit of weight basis. Customer interface terminal 74 displays article data as it is entered through the scanner/scale module 66.

The upper currency module 80 receives currency and coins from a customer as payment for a transaction. The upper currency module 80 also includes a coin dispenser 81 that returns the coin portion of the customer's change while the lower currency module 82 returns the bill portion of the customer's change. The upper currency module 80 may also include a cash recycling unit (not shown) to provide cash received from customers in the change dispensed to customers. The receipt printer module 84 has a receipt dispense slot 85 through which a transaction receipt can be delivered to a customer. The receipt itemizes the articles purchased and the method of payment.

Receipt printer module 84 and scanner/scale module 66 may be separated by a bag well 86 having a security scale 88 for its floor. Bags for storing articles that customers have scanned and weighed are hung from hanging rails 87 in bag well 86. Security scale 88 uses article weight data derived from scanner/scale 66 or a database using a scanned universal product code (UPC) to verify that only the articles scanned are placed on the security scale. Security application programs operating within customer interface terminal 74 monitor security scale 88 to determine whether articles not scanned have been added to the security scale area. A database, disk drive, or other computer peripheral required for station operation may be housed within peripheral tray 89 located within checkstand unit 58.

The self-service checkout station 50 further comprises a payment card reader apparatus 100 which enables a customer to make payment for purchased items. The payment card reader apparatus 100 may support credit card, debit card, and other payment methods. As an example, the payment card reader apparatus 100 may be of the type which reads a magnetic-striped card. Alternatively, the payment card reader apparatus 100 may be of the type which reads an integrated-chip card (i.e., a smart card). It is also conceivable that the payment card reader apparatus 100 may be of the type which is capable of reading more than one type of card. Structure and operation of various types of card readers are conventional and well known and, therefore, will not be described further. For purposes of explanation hereinbelow, a magnetic-striped card in the form of a credit card will be used.

The payment card reader apparatus 100 shown in FIG. 2 comprises a housing enclosure 102 and an electronic controller (not shown in FIG. 2) which may be disposed inside the housing enclosure. Such an electronic controller is shown in FIG. 3 and is designated with reference number “160”. The electronic controller 160 includes an electronic processor 162 and a memory 164 which stores instructions of an application program 166. The electronic processor 162 executes instructions of the application program 166 to process a number of input signals received from a card reader portion 110 and a customer input pad portion 130, and then to provide a number of output signals to a camera portion 150 to control operation of the camera portion based upon the input signals received from the card reader portion and the customer input pad portion. Control of operation of the camera portion 150 will be described in detail later. Structure and operation of electronic processors and memories are known and, therefore, will not be described.

Referring again to FIG. 2, a customer may place articles on feeder belt 60 which is driven in the direction of arrow X to bring articles to the end of the belt where a shut-off mechanism stops the belt. The customer may then remove articles from belt 60 and move them, one at a time, over scanner/scale module 66 for article product data retrieval and/or weighing. Alternatively, the customer may pull a cart containing articles for purchase so it is adjacent feeder unit 62 and place articles from the cart onto scanner/scale module 66. It should be apparent that the flow of the customer is from left to right (as viewed looking at FIG. 1) while the customer is conducting the self-service retail item checkout transaction.

The scanned articles may then be placed in bags on security scale 88. Once all of the articles are scanned, the customer may provide payment through payment card reader apparatus 100 or upper currency module 80, receive change from coin dispenser 81 and lower currency module 82, and a receipt from receipt printer module 84. The customer may then remove the bags from the security scale 88 and leave the checkout station 50. Operation of checkout station 50 is controlled by a processor that is typically incorporated within customer interface terminal 74.

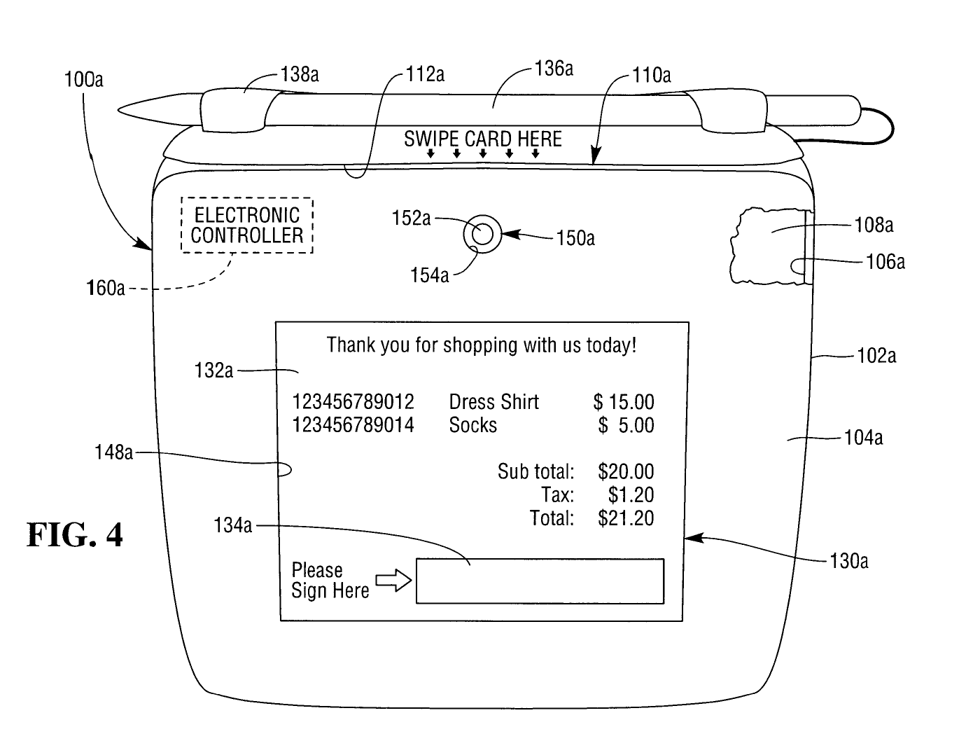

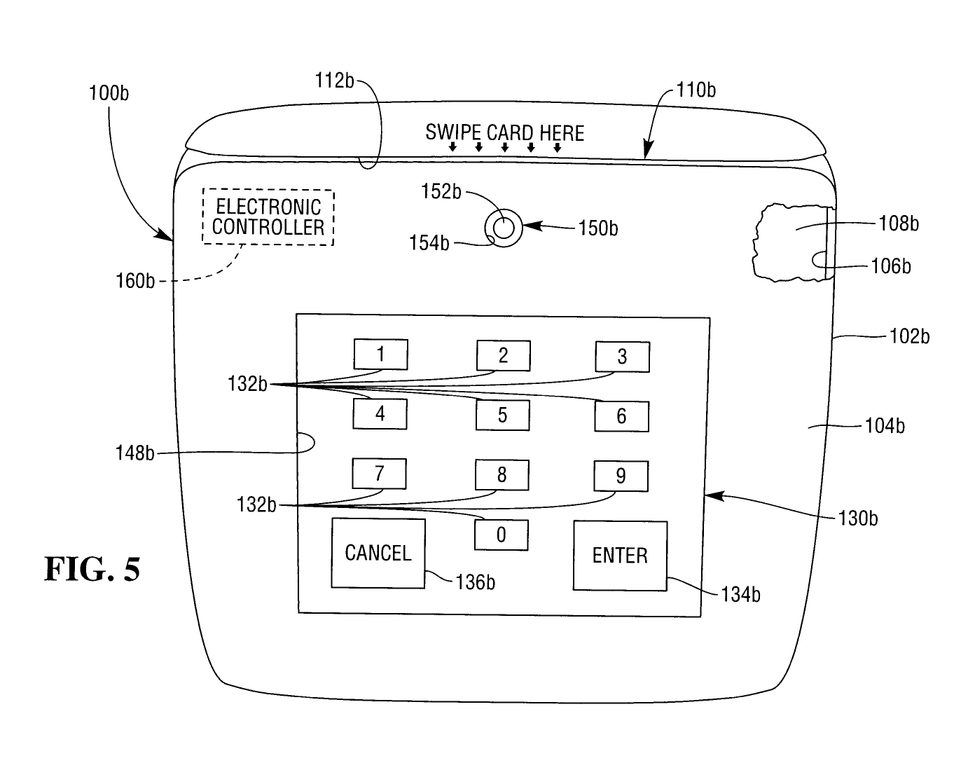

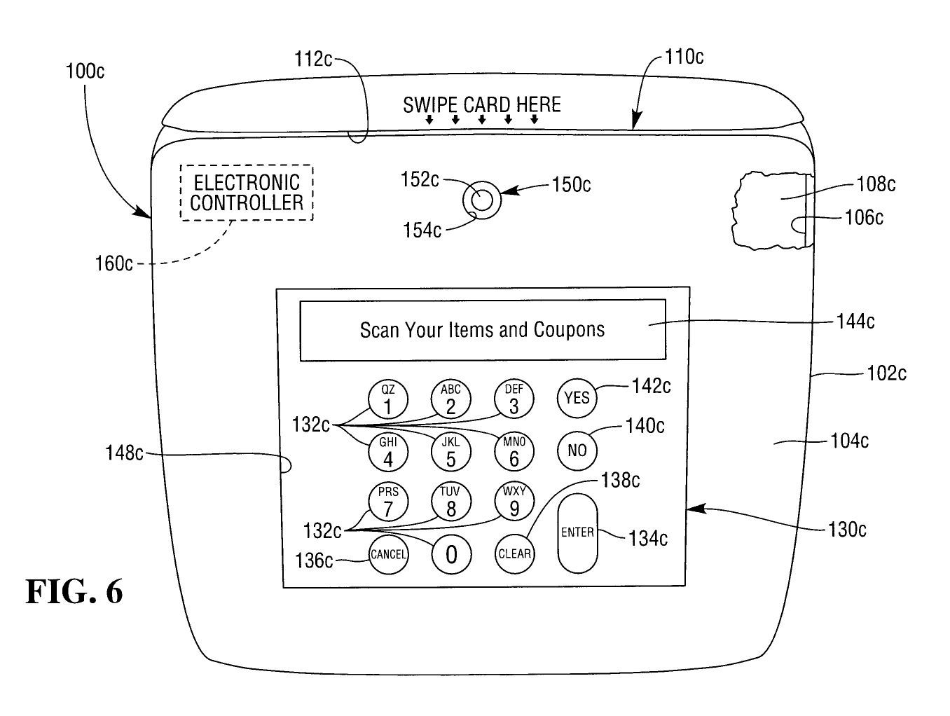

A payment card reader apparatus constructed in accordance with a first embodiment of the present invention is shown in FIG. 4 and is designated with reference number “100a”. A payment card reader apparatus constructed in accordance with a second embodiment of the present invention is shown in FIG. 5 and is designated with reference number “100b”. A payment card reader apparatus constructed in accordance with a third embodiment of the present invention is shown in FIG. 6 and is designated with reference number “100c”. Each of the payment card reader apparatus 100a, 100b, 100c enables a retail customer purchasing goods or services from a retail establishment to make payment for purchased goods or services. Each of the payment card reader apparatus 100a, 100b, 100c will be described in detail hereinbelow.

Referring to FIG. 4, the payment card reader apparatus 100a includes a housing enclosure 102a having a front panel 104a which faces toward the customer. Part of the front panel 104a is shown broken away to show an opening 106a. An interior chamber 108a is visible through the opening 106a and is located behind the front panel 104a. The payment card reader apparatus 100a includes payment card reader portion 110a which is disposed in the interior chamber 108a. Payment card reader portion 110a reads credit card data from a credit card when the customer swipes the credit card along card slot 112a as is known.

Payment card reader apparatus 100a further includes customer input pad portion 130a which is disposed in the interior chamber 108a, and which allows the customer facing the front panel 104a to interact with the customer input pad portion 130a. As shown in FIG. 4, the customer input pad portion 130a is in the form of a signature capture pad having a display region 134a and a signature region 134a which are exposed through an opening 148a of the front panel 104a. The display region 132a provides prompts and data associated with the purchase transaction for the customer to view. The signature region 134a provides a writing surface on which the customer can use pen 136a stored in holder 138a to write his/her signature so that the signature capture pad 130a can capture an electronic copy of the customer's signature. Structure and operation of the signature capture pad 130a are conventional and well known and, therefore, will not be described.

In accordance with one aspect of the first embodiment of the present invention shown in FIG. 4, payment card reader apparatus 100a includes actuatable camera portion 150a which is disposed in the interior chamber 108a. The camera portion 150a has a camera lens 152a which is exposed through opening 154a of the front panel 104a of the housing enclosure 102a to allow the camera portion to capture an image or picture of the customer when the camera portion is actuated. The camera portion 150a may comprise a PC board-mounted mini-camera. Such mini-cameras may be charge-coupled devices (CCDs), and usually operate on 12 VDC power. These mini-cameras may be either color or black and white. A number of PC board-mounted mini-cameras are commercially available. Structure and operation of PC board-mounted mini cameras are known and, therefore, will not be described.

In accordance with another aspect of the first embodiment of the present invention shown in FIG. 4, the signature capture pad 130a provides a trigger signal in response to receiving signature data from the customer. As an example, the trigger signal may be provided immediately in response to the pen 136a first touching writing surface of signature region 134a of the signature capture pad 130a. As another example, the trigger signal may be provided after a predetermined time delay after the pen 136a first touches writing surface of signature region 134a.

When electronic controller 160a receives a trigger signal from signature capture pad 130a, the controller provides a number of output signals to actuate the camera portion 150a. Accordingly, camera portion 150a is actuated in response to trigger signal being received from signature capture pad 130a. Thus, camera portion 150a captures an image or picture of the customer while the customer is providing input data to the customer input pad portion 130a (i.e., the signature capture pad).

Referring to FIG. 5, the payment card reader apparatus 100b includes a housing enclosure 102b having a front panel 104b which faces toward the customer. Part of the front panel 104b is shown broken away to show an opening 106b. An interior chamber 108b is visible through the opening 106b and is located behind the front panel 104b. The payment card reader apparatus 100b includes payment card reader portion 110b which is disposed in the interior chamber 108b. Payment card reader portion 110b reads credit card data from a credit card when the customer swipes the credit card along card slot 112b as is known.

Payment card reader apparatus 100b further includes customer input pad portion 130b which is disposed in the interior chamber 108b, and which allows the customer facing the front panel 104b to interact with the customer input pad portion 130b. As shown in FIG. 5, the customer input pad portion 130b is in the form of a personal identification number (PIN) pad which is exposed through an opening 148b of the front panel 104b. The PIN pad 130b has ten digit keys 132b, an “Enter” key 134b, and a “Cancel” key 136b. Although only twelve different keys are shown in the PIN pad 130b of FIG. 5, it is conceivable that the PIN pad may comprise any number of different keys. Structure and operation of PIN pads are conventional and well known and, therefore, will not be described.

In accordance with one aspect of the second embodiment of the present invention shown in FIG. 5, payment card reader apparatus 100b includes actuatable camera portion 150b which is disposed in the interior chamber 108b. The camera portion 150b has a camera lens 152b which is exposed through opening 154b of the front panel 104b of the housing enclosure 102b to allow the camera portion to capture an image or picture of the customer when the camera portion is actuated. The camera portion 150b may comprise a PC board-mounted mini-camera. Such mini-cameras may be charge-coupled devices (CCDs), and usually operate on 12 VDC power. These mini-cameras may be either color or black and white. A number of PC board-mounted mini-cameras are commercially available. Structure and operation of PC board-mounted mini cameras are known and, therefore, will not be described.

In accordance with another aspect of the second embodiment of the present invention shown in FIG. 5, the PIN pad 130b provides a trigger signal in response to receiving PIN data from the customer. As an example, the trigger signal may be provided immediately in response to the customer pressing a first one of the keys of the PIN pad 130b. As another example, the trigger signal may be provided after a predetermined time delay after the customer has pressed a certain key of the PIN pad 130b.

When electronic controller 160b receives a trigger signal from PIN pad 130b, the controller provides a number of output signals to actuate the camera portion 150b. Accordingly, camera portion 150b is actuated in response to trigger signal being received from PIN pad 130b. Thus, camera portion 150b captures an image or picture of the customer while the customer is providing input data to the customer input pad portion 130b (i.e., the PIN pad).

Referring to FIG. 6, the payment card reader apparatus 100c includes a housing enclosure 102c having a front panel 104c which faces toward the customer. Part of the front panel 104c is shown broken away to show an opening 106c. An interior chamber 108c is visible through the opening 106c and is located behind the front panel 104c. The payment card reader apparatus 100c includes payment card reader portion 110c which is disposed in the interior chamber 108c. Payment card reader portion 110c reads credit card data from a credit card when the customer swipes the credit card along card slot 112c as is known.

Payment card reader apparatus 100c further includes customer input pad portion 130c which is disposed in the interior chamber 108c, and which allows the customer facing the front panel 104c to interact with the customer input pad portion 130c. As shown in FIG. 6, the customer input pad portion 130c is in the form of a key pad which is exposed through an opening 148c of the front panel 104c. The key pad 130c has ten alphanumeric keys 132c, an “Enter” key 134c, a “Cancel” key 136c, a “Clear” key 138c, a “No” key 140c, a “Yes” key 142c, and a display region 144c. The display region 144c provides prompts and data associated with the purchase transaction for the customer to view. Although only fifteen different keys are shown in the key pad 130c of FIG. 6, it is conceivable that the key pad may comprise any number of different keys. Structure and operation of key pads are conventional and well known and, therefore, will not be described.

In accordance with one aspect of the third embodiment of the present invention shown in FIG. 6, payment card reader apparatus 100c includes actuatable camera portion 150c which is disposed in the interior chamber 108c. The camera portion 150c has a camera lens 152c which is exposed through opening 154c of the front panel 104c of the housing enclosure 102c to allow the camera portion to capture an image or picture of the customer when the camera portion is actuated. The camera portion 150c may comprise a PC board-mounted mini-camera. Such mini-cameras may be charge-coupled devices (CCDs), and usually operate on 12 VDC power. These mini-cameras may be either color or black and white. A number of PC board-mounted mini-cameras are commercially available. Structure and operation of PC board-mounted mini cameras are known and, therefore, will not be described.

In accordance with another aspect of the third embodiment of the present invention shown in FIG. 6, the key pad 130c provides a trigger signal in response to receiving keyed-in data from the customer. As an example, the trigger signal may be provided immediately in response to the customer pressing a first one of the keys of the key pad 130c. As another example, the trigger signal may be provided after a predetermined time delay after the customer has pressed a certain key of the key pad 130c.

When electronic controller 160c receives a trigger signal from key pad 130c, the controller provides a number of output signals to actuate the camera portion 150c. Accordingly, camera portion 150c is actuated in response to trigger signal being received from key pad 130c. Thus, camera portion 150c captures an image or picture of the customer while the customer is providing input data to the customer input pad portion 130c (i.e., the key pad).

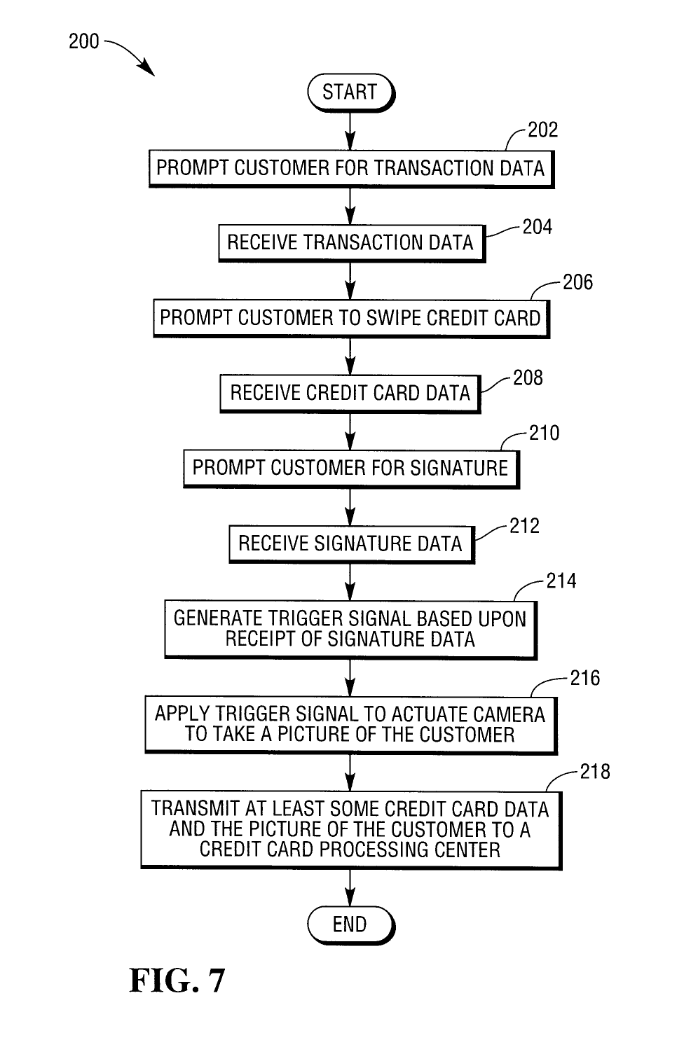

Referring to FIG. 7, a flowchart 200 depicts operation of the payment card reader apparatus 100a shown in FIG. 4. When the customer is prompted for transaction data (step 202) on the customer interface terminal 74 (FIG. 2), the customer provides transaction data associated with the purchase transaction (step 204). The customer is then prompted on either the customer interface terminal 74 or the display region 132a (FIG. 4) of the signature capture pad 130a to swipe a credit card (step 206) through card slot 112a.

After the customer swipes the credit card (step 208), the customer is prompted for a signature (step 210) to be written onto the writing surface of the signature region 134a (FIG. 4) of the signature capture pad 130a. When the customer provides a signature by writing onto the writing surface of the signature region 134a (step 212), the controller 160a generates a trigger signal in response thereto (step 214). The generated trigger signal is applied to the camera portion 150a to actuate the camera portion to take a picture of the customer (step 216). Then, at least some of the credit card data from step 208 and the image or picture of the customer from step 216 are electronically transmitted to the credit card processing center 16 (FIG. 1) for further processing.

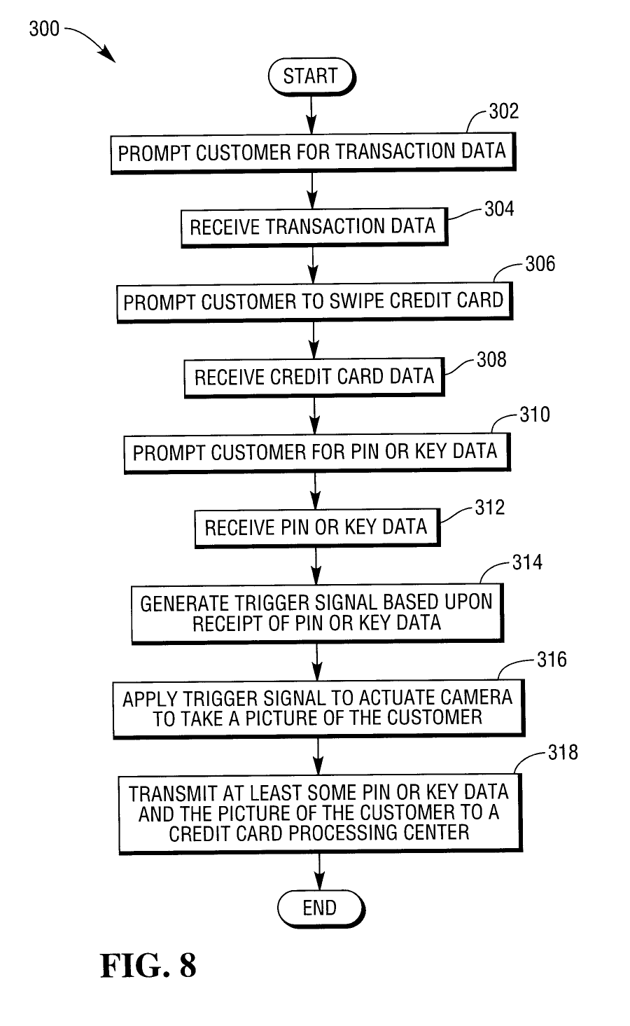

Referring to FIG. 8, a flowchart 300 depicts operation of the payment card reader apparatus 100b shown in FIG. 5 or the payment card reader apparatus 100c shown in FIG. 6. When the customer is prompted for transaction data (step 302) on the customer interface terminal 74 (FIG. 2), the customer provides transaction data associated with the purchase transaction (step 304). The customer is then prompted on either the customer interface terminal 74 or the display region 144c (FIG. 6) of the key pad 130c to swipe a credit card (step 306) through card slot 112b (FIG. 5) or card slot 112c (FIG. 6).

After the customer swipes the credit card (step 308), the customer is prompted (step 310) to enter either PIN data on PIN pad 130b (FIG. 5) or keystroke data on key pad 130c (FIG. 6). When the customer enters data by keying in the data on either PIN pad 130b or key pad 130c (step 312), the controller 160b (FIG. 5) or 160c (FIG. 6) generates a trigger signal in response thereto (step 314). The generated trigger signal is applied to the camera portion 150b (FIG. 5) or 150c (FIG. 6) to actuate the respective camera portion to take a picture of the customer (step 316). Then, at least some of the credit card data from step 308 and the image or picture of the customer from step 316 are electronically transmitted to the credit card processing center 16 (FIG. 1) for further processing.

It should be apparent that each of the different embodiments of the payment card reader apparatus 100a, 100b, 100c described hereinabove comprises a camera portion and a customer input pad portion (such as the signature capture pad shown in FIG. 4, or the PIN pad shown in FIG. 5, or the key pad shown in FIG. 6). Each of the payment card reader apparatus 100a, 100b, 100c provides an integrated and compact device which is used to capture an image or picture of the customer conducting a purchase transaction. The captured image or picture of the customer may be used as proof of occurrence of the purchase transaction in the event there is a dispute in the future as to whether the purchase transaction had ever occurred.

It should also be apparent that an image of the retail customer is captured while input data is still being received from the retail customer. By providing the camera portion 150 (FIG. 2) and the customer input pad portion 130 into an integrated device, better insurance is provided that a good picture of the customer will be captured. This is because the customer will more than likely be looking directly into the lens of the camera portion 150 when the customer is looking at the customer input pad portion 130 to either write a signature on a signature capture pad or enter a sequence of keystrokes on a PIN pad or key pad. Not only is a good picture of the customer better ensured, but also a picture of the face of the customer from a frontal view is captured. A frontal view of the face of the customer is a good picture, if not perhaps the best picture, which uniquely identifies the particular customer.

Although the above description describes a payment card reader portion in the form of a credit card reader, it is conceivable that the payment card reader portion may comprise a different type of card reader. Examples of other types of card reader portions may comprise any type of magnetic-striped type of card reader or any type of integrated-chip type of card reader. An example of a different type of magnetic-striped card reader may be a debit card reader. An example of a type of integrated-chip card reader may be a contactless type of smart card.

Also, although the above description describes a customer input pad portion in the form of a signature capture pad 130a such as shown in FIG. 4, a PIN pad 130b such as shown in FIG. 5, or a key pad 130c such as shown in FIG. 6, it is conceivable that the customer input pad portion may comprise a different type of input pad.

Further, although the above description describes the payment card reader apparatus 100a, 100b, 100c (FIGS. 4-6 respectively) in which the payment card reader portions 110a, 110b, 110c are located in the interior chambers 108a, 108b, 108c, it is conceivable that these payment card reader portions be located outside of the interior chambers and away from both the customer input pad portions 130a, 130b, 130c and the camera portions 150a, 150b, 150c. Only the customer input pad portions 130a, 130b, 130c and the camera portions 150a, 150b, 150c need to be located in the interior chambers 108a, 108b, 108c of the housing enclosures 102a, 102b, 102c to better ensure that a good picture of a frontal view of the face of the customer will be taken.

Although the above description describes the payment card reader apparatus 100a, 100b, 100c (FIGS. 4-6 respectively) being used in a self-service terminal such as the self-service checkout station 50 shown in FIG. 2, it conceivable that the payment card reader apparatus 100a, 100b, 100c may be used in a different type of self-service terminal. As an example, the payment card reader apparatus 100a, 100b, 100c may be used in a self-service type of gasoline pump station. Moreover, the payment card reader apparatus 100a, 100b, 100c may be used in an environment which is not self-service, such as at the POS terminal 12 shown in FIG. 1.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A payment card reader apparatus for enabling a retail customer purchasing goods or services from a retail establishment to make payment for purchased goods or services, the payment card reader apparatus comprising:
a housing enclosure having a front panel which faces toward the retail customer and an interior chamber located behind the front panel;
a payment card reader portion disposed in the interior chamber and for receiving a payment card from the retail customer;
a customer input pad portion disposed in the interior chamber and for (i) receiving input data from the retail customer after the payment card reader portion has received a payment card from the retail customer, and (ii) providing a trigger signal in response to receiving input data from the retail customer; and
an actuatable camera portion disposed in the interior chamber and for, when actuated in response to the trigger signal, capturing an image of the retail customer while the retail customer is providing input data to the customer input pad portion.

2. A payment card reader apparatus according to claim 1, wherein (i) the customer input pad portion disposed in the interior chamber is exposed through the front panel of the housing enclosure to allow the retail customer facing the front panel to interact with the customer input pad portion, and (ii) the camera portion disposed in the interior chamber is also exposed through the front panel of the housing enclosure to allow the camera portion to capture an image of the retail customer when the camera portion is actuated.

3. A payment card reader apparatus according to claim 1, wherein the customer input pad portion comprises at least one of (i) a signature capture pad, (ii) a personal identification number (PIN) pad, and (iii) a key pad.

4. A payment card reader apparatus according to claim 1, wherein the payment card reader portion comprises at least one of (i) a magnetic-striped card reader, and (ii) an integrated-chip card reader.

5. A payment card reader apparatus according to claim 4, wherein (i) the payment card reader portion comprises a credit card reader, and (ii) the customer input pad portion comprises a signature capture pad.

6. A payment card reader apparatus according to claim 1, further comprising a processor arranged to (i) receive a number of input signals from the payment card reader portion, (ii) receive a number of input signals including the trigger signal from the customer input pad portion, and (iii) providing an output signal to actuate the camera portion based upon the input signals received from the payment card reader portion and the customer input pad portion.

7. A payment card reader apparatus for enabling a retail customer purchasing goods or services from a retail establishment to make payment for purchased goods or services, the payment card reader apparatus comprising:
a housing enclosure having a front panel which faces toward the retail customer and an interior chamber located behind the front panel;
a payment card reader portion for receiving a payment card from the retail customer;
a customer input pad portion disposed in the interior chamber and for (i) receiving input data from the retail customer after the payment card reader portion has received a payment card from the retail customer, and (ii) providing a trigger signal in response to receiving input data from the retail customer; and
an actuatable camera portion disposed in the interior chamber and for, when actuated in response to the trigger signal, capturing an image of the retail customer while the retail customer is providing input data to the customer input pad portion, wherein (i) the customer input pad portion disposed in the interior chamber is exposed through the front panel of the housing enclosure to allow the retail customer facing the front panel to interact with the customer input pad portion, and (ii) the camera portion disposed in the interior chamber is exposed through the front panel of the housing enclosure to allow the camera portion to capture an image of the retail customer when the camera portion is actuated.

8. A payment card reader apparatus according to claim 7, wherein the customer input pad portion comprises at least one of (i) a signature capture pad, (ii) a personal identification number (PIN) pad, and (iii) a key pad.

9. A payment card reader apparatus according to claim 7, wherein the payment card reader portion comprises at least one of (i) a magnetic-striped card reader, and (ii) an integrated-chip card reader.

10. A payment card reader apparatus according to claim 9, wherein (i) the payment card reader portion comprises a credit card reader, and (ii) the customer input pad portion comprises a signature capture pad.

11. A payment card reader apparatus according to claim 7, wherein the payment card reader portion is disposed in the interior chamber.

12. A payment card reader apparatus according to claim 7, wherein the payment card reader portion is disposed outside the interior chamber.

13. A payment card reader apparatus according to claim 7, further comprising a processor arranged to (i) receive a number of input signals from the payment card reader portion, (ii) receive a number of input signals including the trigger signal from the customer input pad portion, and (iii) providing an output signal to actuate the camera portion based upon the input signals received from the payment card reader portion and the customer input pad portion.

14. A method of operating a payment card reader apparatus which enables a retail customer purchasing goods or services from a retail establishment to make payment for purchased goods or services, the method comprising:
receiving a payment card from the retail customer;
receiving input data from the retail customer after the a payment card is received from the retail customer;
providing a trigger signal while input data is being received from the retail customer;
electronically by a processor receiving the trigger signal and providing an output signal in response to receiving the trigger signal; and
capturing an image of the retail customer in response to the output signal being provided while input data is still being received from the retail customer.
